(19) United States
(12) Patent Application Publication
(10) Pub. No.: US 2025/0058621 A1
(43) Pub. Date: Feb. 20, 2025

(54) SYSTEMS FOR AN ELECTRIC MOTOR MOUNT

(71) Applicant: Dana Heavy Vehicle Systems Group, LLC, Maumee, OH (US)

(72) Inventors: Vijay GULHANE, Pune (IN); Saket KALE, Pune (IN); Vijay KADAM, Pune (IN)

(21) Appl. No.: 18/450,264

(22) Filed: Aug. 15, 2023

(51) Int. Cl. B60K 8/00

(52) U.S. Cl. CPC B60K 8/00; B60K 2001/001

(57) ABSTRACT

Systems are provided for a motor mount. In one example, a system includes a motor mount physically coupled to an electric motor and a cover of a drive head assembly, the cover physically coupled to an axle housing. The motor mount includes three planes with one of the planes normal to the other two.

### TECHNICAL FIELD

The present description relates generally to an electric motor mount for supporting an electric motor on an axle.

### BACKGROUND AND SUMMARY

Vehicles are continuously receiving electrified modifications to reduce emissions and improve performance. These modifications may utilize preexisting mounts and components used in internal combustion engine vehicles. However, some of these modifications may not interact as desired with preexisting system architectures. Other methods and systems contrary to those already present may be desired.

For example, if the electric motor is mounted to an axle, it may create an increase in unsprung mass compared to a drive axle of an internal combustion engine vehicle. The increase in unsprung mass results in an increased stress to the axle, which may reduce a longevity thereof. Additionally, a motor support bracket and bolts thereof are exposed to the increased stress.

The issues described above may be at least partially solved by a system including a differential housing mounted on an axle, a gearbox outwardly extending from a cover of the differential housing, and an electric motor physically coupled to the gearbox at a first end and to a mount at a second end opposite the first end, wherein the mount is further physically coupled to the cover. In this way, a longevity of the axle and the mount may be increased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain;

FIG. 2 is an e-axle motor assembly, according to an example of the present disclosure;

FIG. 3 is a detailed view of an electric motor and a drive head assembly of the e-axle motor assembly, according to an example of the present disclosure;

FIGS. 4A and 4B are a view of the motor support bracket physically coupled to the electric motor and the drive head assembly, according to an example of the present disclosure;

FIGS. 5A, 5B, 5C, and 5D are different views of a first embodiment of the motor support bracket, according to an example of the present disclosure;

FIG. 6 is a view of a second embodiment of the motor support bracket physically coupled to the electric motor and the drive head assembly, according to an example of the present disclosure; and

FIGS. 7A, 7B, 7C, and 7D are view of the second embodiment of the motor support bracket, according to an example of the present disclosure.

### DETAILED DESCRIPTION

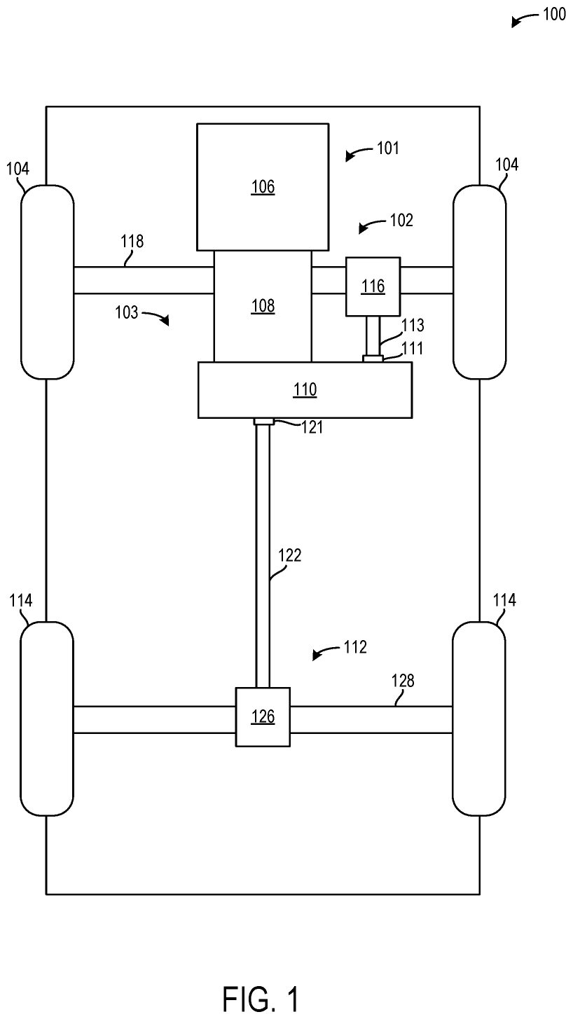

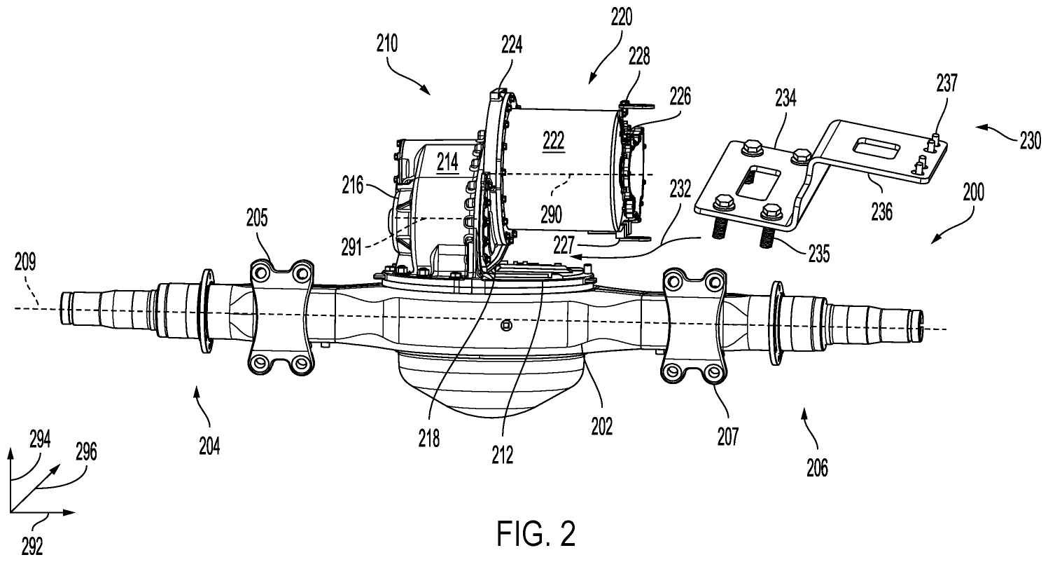

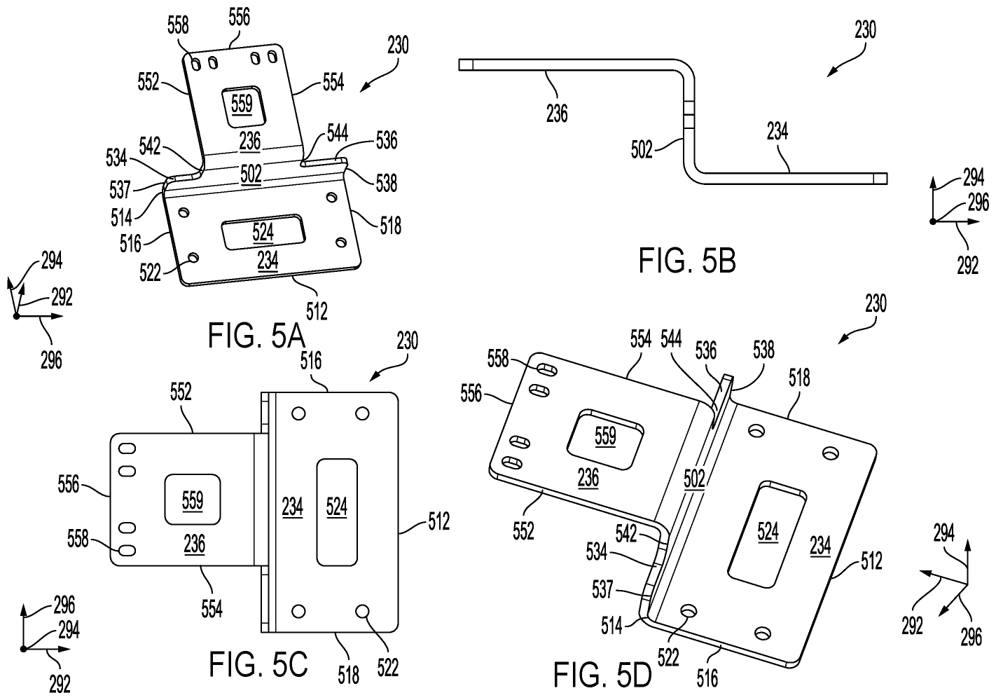

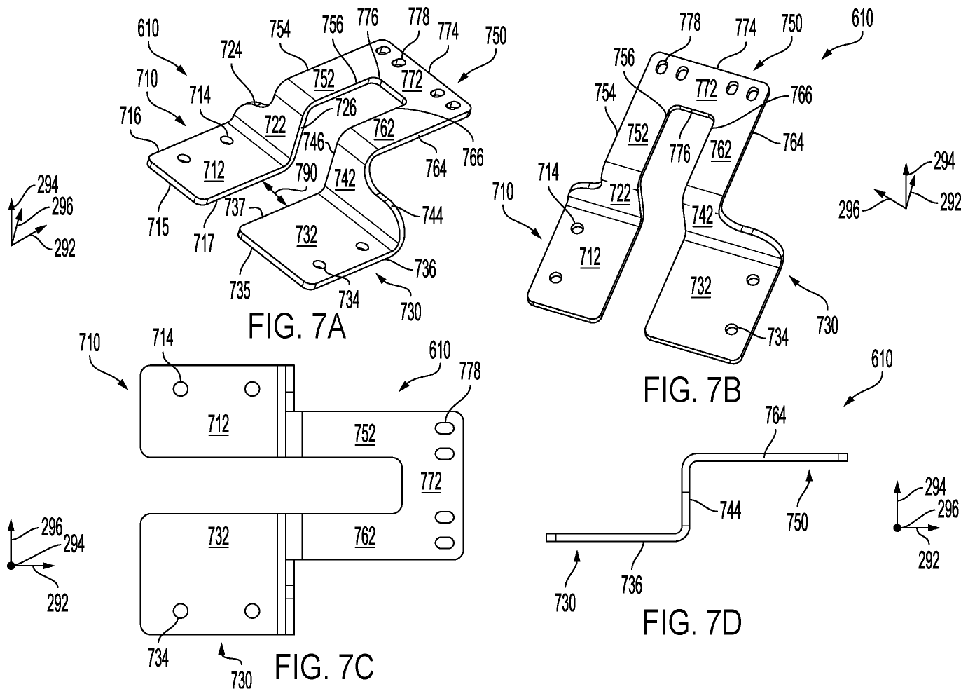

The following description relates to a system for a mount. For example, a vehicle may include a powertrain having an electric motor mounted to a component of the vehicle with the electric motor mount. An example vehicle is shown in FIG. 1. The motor may be mounted to a drive head assembly on an axle as shown in FIGS. 2-4B and 6. FIGS. 5A-5D illustrate a first embodiment of the electric motor mount. FIGS. 7A-7D illustrate a second embodiment of the electric motor mount.

FIGS. 1-7D show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred to as such, in one example. It will be appreciated that one or more components referred to as being “substantially similar and/or identical” differ from one another according to manufacturing tolerances (e.g., within 1-5% deviation). As used herein, the term “approximately” is construed to mean plus or minus five percent of the range unless otherwise specified. FIGS. 2-7D are shown approximately to scale, however, other dimensions may be used if desired.

Turning now to FIG. 1, a vehicle 100 is shown comprising a powertrain 101 and a drivetrain 103. The powertrain comprises a prime mover 106 and a drive head assembly 108. The prime mover 106 may be an internal combustion engine or an electric motor, for example, and is operated to provide rotary power to the drive head assembly 108. The drive head assembly 108 may be any type of transmission, such as a manual transmission, an automatic transmission, or a continuously variable transmission. Additionally or alternatively, the drive head assembly 108 may be a gearbox and a differential. The drive head assembly 108 receives the rotary power produced by the prime mover 106 as an input and outputs rotary power to the drivetrain 103 in accordance with a selected gear or setting.

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the drive head assembly 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing. The drive head assembly 108 and the prime mover 106 are mounted on the first set of axle shafts 118.

In one example, the prime mover 106 is an electric machine. The prime mover 106 may be interchangeably referred to as an electric motor herein. The electric motor 106 may include a motor operation and a regenerate operation. The motor operation may consume power supplied from an energy storage device (e.g., a battery). The regenerate operation may supply power to the energy storage device.

Turning now to FIG. 2, it shows an axle assembly 200. The axle assembly 200 may include an axle housing 202 arranged between a first axle arm 204 and a second axle arm 206. A first axle mount 205 may be arranged on the first axle arm 204 between an extreme end of the first axle arm 204 and the axle housing 202. A second axle mount 207 may be arranged on the second axle arm 206 between an extreme end of the second axle arm 206 and the axle housing 202. In one example, the axle assembly 200 may be identical to the first set of axle shafts 118 or the second set of axle shafts 128 of FIG. 1.

A drive head assembly 210 is coupled to the axle housing 202. In one example, a cover 212 may seal the axle housing 202 and include one or more through-holes. Fasteners may extend through the one or more through-holes and thread with corresponding openings in the axle housing 202 for fastening the drive head assembly 210 thereto. The drive head assembly 210 may extend from the cover 212 in a direction normal to a central axis 209 of the axle assembly 200.

An axis system comprises three axes, namely a lateral axis 292, an axial axis 294, and a transverse axis 296. Each of the axes are normal to one another. In one example, gravity is parallel to the lateral axis 292. The central axis 209 is parallel to the lateral axis 292.

The drive head assembly 210 may extend in a direction parallel to the axial axis 294 away from the axle housing 202. The drive head assembly 210 may include a main body 214 comprising an arc shape. In one example, the main body 214 is a partial drum shape (e.g., a partial cylinder) that is interrupted by the axle housing 202. That is to say, a partial cylinder may include a linear side connected to a cylindrical shape. The drive head assembly 210 may further include a first side 216 that faces the first axle arm 204. The first side 216 may include a half-circle shape. The drive head assembly 210 may further include a second side 218 that faces the second axle arm 206. The second side 218 may be opposite to the first side 216 relative to the main body 214. The second side 218 may include a half-circle shape identical to a shape of the first side 216.

An electric motor 220 may be mounted on the drive head assembly 210. In one example, the electric motor 220 may include a main body 222. The main body 222 may include a cylindrical shape having a first diameter. The main body 222 may be sandwiched by a first electric motor side 224 and a second electric motor side 226. Each of the first and second electric motor sides 224, 226 may include a diameter larger than the first diameter. The first electric motor side 224 may be in face-sharing contact with the second side 218 of the drive head assembly 210. In one example, the first electric motor side 224 is offset with the second side 218 of the drive head assembly 210 such that a portion of the first electric motor side 224 extends further along the axial axis 294 away from the axle housing 202 than the second side 218 of the drive head assembly 210. Additionally or alternatively, a central axis 290 of the electric motor 220 may be misaligned with a central axis 291. The central axis 290 is parallel to the central axis 291 and the central axis 209.

The second side 226 may further include a pair of mounting brackets, including a first mounting bracket 227 and a second mounting bracket 228. The pair of mounting brackets may be arranged at opposite ends of a diameter of the second electric motor side 226. Each of the first mounting bracket 227 and the second mounting bracket 228 may include mounting points, such as through-holes, configured to receive one or more fasteners. The mounting points may allow a separate device, such as the electric motor mount 230, to physically couple to the second side 226 of the electric motor.

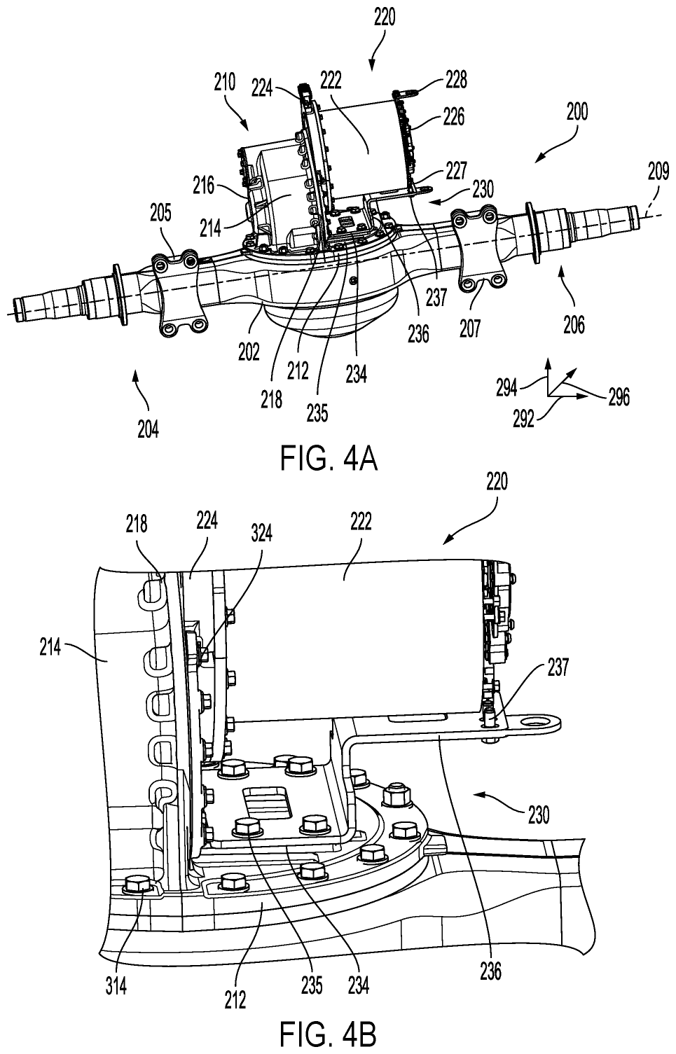

As illustrated via arrow 232, the electric motor mount 230 may be positioned between the electric motor 220 and the cover 212. The electric motor mount 230 may be physically coupled to the cover 212 at a first portion 234 via a first plurality of fasteners 235. The electric motor mount 230 may be physically coupled to the first mounting bracket 227 at a second portion 236 via a second plurality of fasteners 237. Alternatively, mounting holes located in the second electric motor side 226 can also be integral part of a round portion of the main body 222. The electric motor mount 230 is described in greater detail with respect to FIGS. 4A-5D.

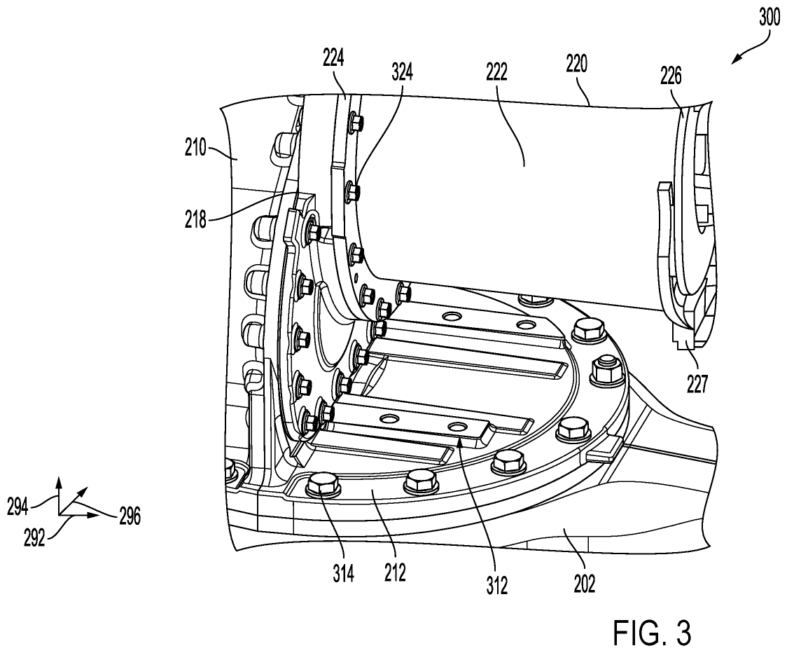

Turning now to FIG. 3, it shows a detailed view 300 of the cover 212. In one example, the cover 212, the main body 214, the first side (e.g., the first side 216 of FIG. 2), and the second side 218 are a contiguous component with one or more through-holes for receiving fasteners. The cover 212 may be directly coupled to the axle housing 202 via a plurality of fasteners 314.

The cover 212 may include a plurality of mount openings 312 for receiving a plurality of fasteners. In one example, the first plurality of fasteners 235 may thread into the plurality of mount openings 312. The first plurality of fasteners 235 may physically couple the electric motor mount (e.g., electric motor mount 230 of FIG. 2) to the cover 212 at a location axially below the main body 222 of the electric motor 220. In one example, the location is between the electric motor 220 and the cover 212 and lateral to the drive head assembly 210.

The electric motor 220 may be physically coupled to the second side 218 via a plurality of fasteners 324. In one example, the first electric motor side 224 is physically coupled to and in face-sharing contact with the second side 218 via the plurality of fasteners 324. In some examples, when the electric motor mount is not installed, the electric motor 220 is cantilevered to the second side 218 of the drive head assembly 210. The plurality of fasteners 324 may extend in a direction parallel to the lateral axis 292. The plurality of fasteners 314 may extend in a direction parallel to the axial axis 294 and normal to the plurality of fasteners 324.

Turning now to FIGS. 4A and 4B, they show the electric motor mount 230 physically coupled to each of the cover 212 and the electric motor 220. FIGS. 4A and 4B are described in tandem herein.

As illustrated, the first portion 234 of the electric motor mount 230 is in face-sharing contact with the cover 212. The first portion 234 is fixedly coupled to the cover 212 via the first plurality of fasteners 235. The second portion 236 of the electric motor mount 230 is in face-sharing contact with the main body 222 and the second electric motor side 226 of the electric motor 220. The second portion 236 is fixedly coupled to the second electric motor side 226 via the second plurality of fasteners 237.

The portions of the electric motor mount 230 in face-sharing contact with the cover 212 and the electric motor 220 are parallel to a plane formed along the lateral axis 292 and the transverse axis 296. The electric motor mount 230 may further include a third portion (e.g., third portion 502 of FIGS. 5A-5D) arranged along a plane orthogonal to the planes of the first portion 234 and the second portion 236.

Turning now to FIGS. 5A-5D, they show various views of the electric motor mount 230. The electric motor mount 230 includes the first portion 234 and the second portion 236 parallel to one another along a first plane. A third portion 502 may be arranged between and coupled to each of the first portion 234 and the second portion 236. In one example, the electric motor mount 230 is a single piece including the first portion 234, the second portion 236, and the third portion 502.

The first portion 234 may include a rectangular shape comprising a first longitudinal side 512, a second longitudinal side 514, a first lateral side 516, and a second lateral side 518. The first longitudinal side 512 and the second longitudinal side 514 are parallel to one another. The first lateral side 516 and the second lateral side 518 are parallel to one another and normal to the first and second longitudinal sides 512, 514, respectively. The first portion 234 further includes a plurality of through-holes 522. The plurality of through-holes 522 may be arranged in a rectangular pattern, wherein each of the plurality of through-holes 522 is arranged proximally to corners of the first portion 234. The plurality of through-holes 522 are arranged adjacent to the first lateral side 516 and the second lateral side 518.

A central opening 524 may be arranged at a central region of the first portion 234. The central opening 524 may include a rectangular shape. In one example, a proportion of the dimensions of the central opening 524 may be equal to a proportion of the dimensions of the first portion 234. That is to say, the central opening 524 may be a rectangle with smaller dimensions relative to the first portion 234.

The third portion 502 may extend orthogonally from the second longitudinal side 514 along a third plane. The third plane may be perpendicular to the first plane of the first portion 234 and the second plane of the second portion 236. The third portion 502 includes a first half defined by the second longitudinal side 514, a first longitudinal section 534, a second longitudinal section 536, a first axial section 537, and a second axial section 538. The first axial section 537 and the second axial section 538 may be identical and extend in a direction parallel to the axial axis 294. The first longitudinal section 534 and the second longitudinal section 536 may be identical and extend in a direction parallel to the transverse axis 296. The first longitudinal section 534 and the second longitudinal section 536 may be separated by a second half of the third portion 502. A second half may include a third axial section 542 and a fourth axial section 544. The third axial section 542 and the fourth axial section 544 may be parallel to one another and the first axial section 537 and the second axial section 538. In one example, a first distance between the third axial section 542 and the fourth axial section 544 is less than a second distance between the first axial section 537 and the second axial section 538. In one example, the distances are widths, wherein the first portion 234 comprises a width equal to the second distance and the second portion 236 comprises a width equal to the first distance.

The second portion 236 may include a third lateral side 552 opposite a fourth lateral side 554. The third lateral side 552 and the fourth lateral side 554 may transition to a third longitudinal side 556, normal to each of the third and fourth lateral sides 552, 554. In one example, the second portion 236 may include a rectangular shape. The rectangular shape of the second portion 236 may include a long axis that is normal to a long axis of the first portion 234. In one example, the long axis of the second portion 236 is parallel to the third lateral side 552 and the fourth lateral side 554. The long axis of the first portion 234 is parallel to the first longitudinal side 512 and the second longitudinal side 514.

The second portion 236 may further include a second plurality of through-holes 558. The second plurality of fasteners (e.g., second plurality of fasteners 237 of FIG. 2) may extend through the second plurality of through-holes 558 and thread with a mount of the electric motor. The second portion 236 may further include a central opening 559. The central opening 559 may be equidistant to each of the third lateral side 552, the fourth lateral side 554, and the third longitudinal side 556. The central opening 559 may reduce a weight of the electric motor mount 230. The central opening 559 may be a rectangular shape, a triangular shape, a circular shape, or the like.

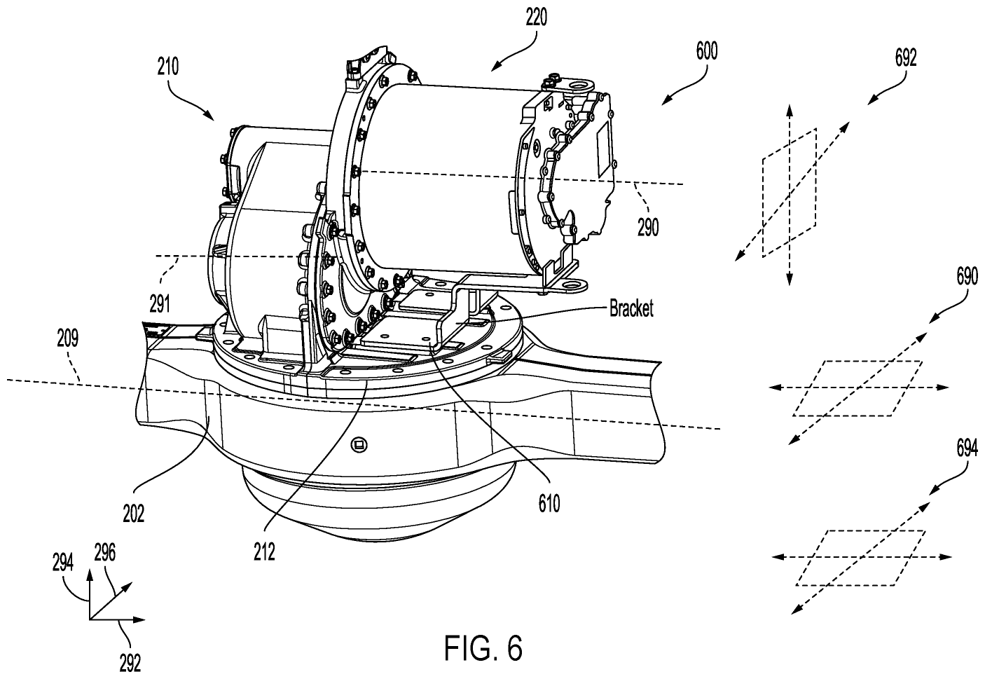

Turning now to FIG. 6, it shows a second embodiment 600 of an electric motor mount 610. The electric motor mount 610 may be used similarly to the electric motor mount 230 of FIGS. 2-5D. A shape of the electric motor mount 610 may differ from the shape of the electric motor mount 230. The electric motor mount 610 is arranged between the electric motor 220 and the cover 212. The electric motor mount 610 is physically coupled to each of the cover 212 and the electric motor 220.

The electric motor mount 610 may be arranged in three planes, including a first plane 690, a second plane 692, and a third plane 694. The electric motor mount 610 may include a first section arranged in the first plane 690. In one example, the first section may include a first arm 710 and a second arm 730 as shown in FIGS. 7A-7C. The electric motor mount 610 may include a second section arranged in the second plane 692, normal to the first plane 690. The second section may include transitions, such as a first arm transition 722 and a second arm transition 742 of FIGS. 7A-7C. The electric motor mount 610 may include a third section arranged in the third plane 694, which is parallel to the first plane 690 and normal to the second plane 692.

In one example, the central axis 290 of the electric motor 220 illustrates an axis about which an electric motor shaft rotates. The central axis 291 of the drive head assembly 210 may represent an axis about which shafts and/or gears of the drive head rotate. The first plane 690 and the third plane 694 may be parallel to the central axis 290 and the central axis 291. The second plane 692 may be normal to the central axis 290 and the central axis 291.

Turning now to FIGS. 7A, 7B, 7C, and 7D, they show different views of the electric motor mount 610. The electric motor mount 610 may include a first arm 710, a second arm 730, and a bridge 750. The first arm 710 may include a first body 712 comprising a plurality of openings 714. The first arm 710 may include a first lateral side 715, a first longitudinal side 716, and a second longitudinal side 717. The first longitudinal side 716 and the second longitudinal side 717 are parallel to one another and normal to the first lateral side 715.

The second arm 730 may include a first lateral side 735, a first longitudinal side 736, and a second longitudinal side 737. The first longitudinal side 736 and the second longitudinal side 737 are parallel to one another and normal to the first lateral side 735. Additionally, or alternatively, a gap 790 is arranged between the second longitudinal side 717 and the second longitudinal side 737.

The first arm 710 and the second arm 730 may be identical to one another in shape. Dimensions of the first arm 710 and the second arm 730 may differ. For example, the first arm 710 may be a rectangle and the second arm 730 may be a rectangle larger than the first arm 710. Additionally, or alternatively, the first arm 710 and the second arm 730 may be squares.

A plurality of openings 714 may be arranged on the first body 712. The plurality of openings 714 may be adjacent to the first longitudinal side 716. Fasteners may extend through the plurality of openings 714 and physically couple the first body 712 to a cover (e.g., cover 212 of FIG. 3) via the plurality of mount openings (e.g., the plurality of mount openings 312).

A first arm transition 722 may extend from the first body 712. In one example, the first body 712 is arranged along the first plane 690 of FIG. 6 defined by the lateral and transverse axes and the first arm transition 722 is arranged along a second plane 692 of FIG. 6 defined by the axial and transverse axes, orthogonal to the first plane. The first arm transition 722 may include a curved edge 724. The curved edge 724 may curve inward such that a width of the first arm transition 722 is reduced relative to a width of the first body 712.

A second arm transition 742 may extend from the second body 732. The second body 732 may be parallel to the first plane and the second arm transition 742 may be parallel to the second plane. The second arm transition 742 may include a curved edge 744. The curved edge 744 may curve inward such that a width of the second arm transition 742 is reduced relative to a width of the second body 732.

Each of the first arm transition 722 and the second arm transition 742 may include a linear edge 726, 746, respectively. In one example, the linear edges 726, 746 are continuations of the second longitudinal sides 717, 737, respectively. A size of the gap 790 may be maintained between the linear edges 726, 746.

A bridge 750 may extend from each of the first arm transition 722 and the second arm transition 742 in the third plane 694 of FIG. 6 defined by the lateral and transverse axes. In one example, the third plane is parallel to the first plane and normal to the second plane. The bridge 750 may include a U-shape including a first section 752, a second section 762, and a third section 772. The first section 752 may interface with and extend from the first arm transition 722. The second section 762 may interface with and extend from the second arm transition 742. The third section 772 may interface with and extend from each of the first section 752 and the second section 762.

The first section 752 may include a linear outer edge 754 parallel to a linear inner edge 756. The second section 762 may include a linear outer edge 764 parallel to a linear inner edge 766. The third section 772 may include a linear outer edge 774 parallel to a linear inner edge 766. Each of the linear outer and inner edges may be continuous with one another. That is to say, the electric motor mount 610 may be a single piece with no disruptions or interferences along its edges and surfaces. A size of the gap 790 is maintained between the linear inner edges 756 and 766.

The third section 772 may include a plurality of openings 778 arranged adjacent to its linear outer edge 774. The plurality of openings 778 may be configured to receive a plurality of fasteners for physically coupling the electric motor mount 610 to an electric motor (e.g., electric motor 220 of FIG. 6).

In one example, based on a packaging space availability and mating parts shapes, the electric motor mounts may be different shapes and sizes. In one example, the electric motor mount 230 of FIG. 2 may be stiffer than the electric motor mount 610. Additionally or alternatively, the electric motor mount 610 may be lighter than the electric motor mount 230 of FIG. 2.

The disclosure provides support for a system including an axle, a drive head assembly, an electric motor, and an electric motor mount physically coupled to the electric motor and a cover of the drive head assembly, wherein the cover is physically coupled to the axle. A first example of the system further includes where a plurality of fasteners physically couples the electric motor mount to the electric motor and the cover, and wherein the plurality of fasteners is parallel to a single axis. A second example of the system, optionally including the first example, further includes where the electric motor mount comprises a first portion parallel to a second portion, and a third portion normal to each of the first and second portions. A third example of the system, optionally including one or more of the previous examples, further includes where the third portion transitions in width to match of a width of the first portion and a width of the second portion. A fourth example of the system, optionally including one or more of the previous examples, further includes where the electric motor is physically coupled to a side of the drive head assembly. A fifth example of the system, optionally including one or more of the previous examples, further includes where a central axis of the electric motor is parallel to a central axis of the axle. A sixth example of the system, optionally including one or more of the previous examples, further includes where portions of the electric motor mount in face-sharing contact with the electric motor and the cover are parallel to the central axis of the electric motor and the central axis of the axle. A seventh example of the system, optionally including one or more of the previous examples, further includes where a portion of the electric motor mount spaced away from the electric motor and the cover is normal to the central axis of the electric motor and the central axis of the axle.

The disclosure provides additional support for an assembly including a drive head assembly mounted on an axle, wherein the drive head assembly comprises a cover physically coupled to an axle housing, a gearbox housing extending from the cover in a direction normal to a central axis of the axle, and an electric motor comprising a first side and a second side opposite to the first side, wherein the first side is physically coupled to the gearbox housing and the second side is physically coupled to an electric motor mount, wherein the electric motor mount is physically coupled to the cover. A first example of the assembly further includes where the electric motor mount comprises three planes, wherein one of the planes is perpendicular to the other planes. A second example of the assembly, optionally including the first example, further includes where the other planes are parallel to one another. A third example of the assembly, optionally including one or more of the previous examples, further includes where the electric motor mount comprises two sections parallel one another and in face-sharing contact with the cover and the electric motor, and an interconnecting section normal to the two sections and spaced away from the cover and the electric motor. A fourth example of the assembly, optionally including one or more of the previous examples, further includes where the electric motor mount is a single, continuous piece. A fifth example of the assembly, optionally including one or more of the previous examples, further includes where a plurality of fasteners physically couples the electric motor mount to the cover and the electric motor. A sixth example of the assembly, optionally including one or more of the previous examples, further includes where the electric motor mount comprises a bend.

The disclosure provides further support for an axle assembly including a first section parallel to a first plane, a second section parallel to a second plane, the second plane different than and parallel to the first plane, and a third section parallel to a third plane, the third plane normal to each of the first plane and the second plane; wherein the first section is physically coupled to a cover of a drive head assembly and the second section is physically coupled to a first end of a motor, and wherein a second end of the motor is physically coupled to a side of the drive head assembly, the second end opposite the first end. A first example of the axle assembly further includes where the side of the drive head assembly is normal to the cover. A second example of the axle assembly, optionally including the first example, further includes where the motor is an electric motor. A third example of the axle assembly, optionally including one or more of the previous examples, further includes where a first plurality of fasteners extends in a direction parallel to the third plane and physically couple the first section to the cover. A fourth example of the axle assembly, optionally including one or more of the previous examples, further includes where a second plurality of fasteners extend in a direction parallel to the third plane and physically couple the second section to the first end of the motor.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
an axle;
a drive head assembly;
an electric motor; and
an electric motor mount physically coupled to the electric motor and a cover of the drive head assembly, wherein the cover is physically coupled to the axle.

2. The system of claim 1, wherein a plurality of fasteners physically couples the electric motor mount to the electric motor and the cover, and wherein the plurality of fasteners is parallel to a single axis.

3. The system of claim 1, wherein the electric motor mount comprises a first portion parallel to a second portion, and a third portion normal to each of the first and second portions.

4. The system of claim 3, wherein the third portion transitions in width to match of a width of the first portion and a width of the second portion.

5. The system of claim 1, wherein the electric motor is physically coupled to a side of the drive head assembly.

6. The system of claim 1, wherein a central axis of the electric motor is parallel to a central axis of the axle.

7. The system of claim 6, wherein portions of the electric motor mount in face-sharing contact with the electric motor and the cover are parallel to the central axis of the electric motor and the central axis of the axle.

8. The system of claim 7, wherein a portion of the electric motor mount spaced away from the electric motor and the cover is normal to the central axis of the electric motor and the central axis of the axle.

9. An assembly, comprising:
a drive head assembly mounted on an axle, wherein the drive head assembly comprises a cover physically coupled to an axle housing;
a gearbox housing extending from the cover in a direction normal to a central axis of the axle; and
an electric motor comprising a first side and a second side opposite to the first side, wherein the first side is physically coupled to the gearbox housing and the second side is physically coupled to an electric motor mount, wherein the electric motor mount is physically coupled to the cover.

10. The assembly of claim 9, wherein the electric motor mount comprises three planes, wherein one of the planes is perpendicular to the other planes.

11. The assembly of claim 10, wherein the other planes are parallel to one another.

12. The assembly of claim 9, wherein the electric motor mount comprises two sections parallel one another and in face-sharing contact with the cover and the electric motor, and an interconnecting section normal to the two sections and spaced away from the cover and the electric motor.

13. The assembly of claim 9, wherein the electric motor mount is a single, continuous piece.

14. The assembly of claim 9, wherein a plurality of fasteners physically couples the electric motor mount to the cover and the electric motor.

15. The assembly of claim 9, wherein the electric motor mount comprises a bend.

16. An axle assembly, comprising:
a motor mount comprising a first section parallel to a first plane, a second section parallel to a second plane, the second plane different than and parallel to the first plane, and a third section parallel to a third plane, the third plane normal to each of the first plane and the second plane; wherein
the first section is physically coupled to a cover of a drive head assembly and the second section is physically coupled to a first end of a motor, and wherein a second end of the motor is physically coupled to a side of the drive head assembly, the second end opposite the first end.

17. The axle assembly of claim 16, wherein the side of the drive head assembly is normal to the cover.

18. The axle assembly of claim 16, wherein the motor is an electric motor.

19. The axle assembly of claim 16, wherein a first plurality of fasteners extends in a direction parallel to the third plane and physically couple the first section to the cover.

20. The axle assembly of claim 19, wherein a second plurality of fasteners extends in a direction parallel to the third plane and physically couple the second section to the first end of the motor.
